(19) United States
(12) Patent Application Publication
(10) Pub. No.: US 2026/0062622 A1
(43) Pub. Date: Mar. 5, 2026

(54) METHOD FOR HYDRODEOXYGENATION OF FEEDSTOCKS OF BIOLOGICAL ORIGIN

(71) Applicant: Chevron U.S.A. Inc., San Ramon, CA (US)

(72) Inventors: Rong HE, Kensington, CA (US); Yu-Tung TSAI, Richmond, CA (US); Bi-Zeng ZHAN, Albany, CA (US)

(73) Assignee: Chevron U.S.A. Inc., San Ramon, CA (US)

(21) Appl. No.: 19/312,437

(22) Filed: Aug. 28, 2025

Related U.S. Application Data
(60) Provisional application No. 63/687,964, filed on Aug. 28, 2024.

(51) Int. Cl. C10G 3/00; B01J 21/04; B01J 27/19; B01J 35/51; B01J 35/61; B01J 35/63; B01J 35/64

(52) U.S. Cl. CPC C10G 3/50; B01J 21/04; B01J 27/19; B01J 35/51; B01J 35/615; B01J 35/635; B01J 35/638; B01J 35/647; C10G 2300/1011; C10G 2300/70

(57) ABSTRACT

The present process effectively produces hydrocarbon products upon hydrotreating a feedstock of biological origin. The process comprises first providing a bio feedstock, then passing the feedstock to a reactor comprising a catalyst comprised of about 6 to 16 wt. % Mo, 0.1 to 1.3 wt. % Ni, and 0.5 to 2.9 wt. % P. The bio feedstock is then reacted over the catalyst.

### CROSS REFERENCE TO RELATED APPLICATIONS

This application claims priority to U.S. Provisional Application Ser. No. 63/687,964 filed Aug. 28, 2024, the complete disclosure of which is incorporated herein by reference in its entirety.

### TECHNICAL FIELD

The method relates to hydrodeoxygenation of feedstocks of biological origin to produce renewable fuels. The method employs a specific catalyst to achieve high activity and selectivity.

### BACKGROUND

Producing renewable fuels from feedstocks of biological origin requires a hydrodeoxygenation reaction, i.e., removal of oxygen by catalytic reaction with hydrogen. The feedstocks include but are not limited to pyrolysis oil from wood or waste, tall oil pitch, animal fats, vegetable oils, and restaurant greases, waste industrial frying oils. The preferred reaction pathway involves only C—O bond cleavage with no C—C bond cleavage, which forms unwanted CO, CO₂ in product gas and causes yield loss.

In the case of feedstocks of fats, oils, and greases, the preferred hydrodeoxygenation (HDO) reaction pathway produces only water as a by-product besides n-paraffins and propane. The decarbonylation and decarboxylation pathways produce CO (and water) and CO₂ respectively besides n-paraffins with one less carbon number than the original fatty acid (as well as propane). For a seed oil such as canola and soybean oil with high concentrations of C₁₈ fatty acids (and very little C₁₇ fatty acids) in the triglyceride structure, this can be measured by the ratio of normal C₁₇ alkanes vs. the sum of normal C₁₇ and C₁₈ alkanes in the liquid product. This ratio is referred to as HDO efficiency. Similar principles apply to other feedstocks of biological origin.

It is commonly accepted that a monometallic molybdenum catalyst is preferred over a bimetallic catalyst with either nickel or cobalt as promoters to the molybdenum. To promote these reactions, catalysts containing primarily inorganic oxides such as alumina, silica, titania, zirconia, as well as carbon with a small amount of Group VI metal sulfides as the active phase are commonly used.

For example, U.S. Patent No. 8,026,0401 claims a process where a monometallic molybdenum catalyst produces a partially hydrodeoxygenated stream that is subsequently converted to hydrocarbon over another bimetallic catalyst of a NiMo, CoMo, and NiW type. The HDO efficiency of this process is 80%.

U.S. Pat. No. 8,912,375 discloses a process for coprocessing material of biological and fossil origin with a supported, unpromoted Mo catalyst having Mo content of 0.1 to 20 wt. %. The support has a bimodal porous structure with at least 2 vol % of total pore volume associated with pores with a diameter larger than 50 nm.

U.S. Pat. No. 7,560,407 discloses a catalyst carrier impregnating solution that can be prepared with a Ni to Mo molar ratio of 0.05 to 0.45, and P to Mo molar ratio of 0.05 to 0.25.

A process for hydrodeoxygenating renewable, bio feedstocks that offers high activity and selectivity would be of great benefit to the industry. Such a process could advance the acceptance of hydrodeoxygenating bio feedstocks in the eventual production of renewable fuel products and chemicals.

### SUMMARY

The present process with high activity and selectivity produces products upon hydrotreating a feedstock, starting materials, of biological origin, i.e., a bio feedstock. The process comprises first providing a bio feedstock, then passing the feedstock to a reactor comprising a catalyst comprised of about 6 to 16 wt. % Mo, 0.1 to 1.3 wt. % Ni and 0.5 to 2.9 wt. % P. The remainder of the catalyst comprises a support material. The bio feedstock is then reacted over the catalyst. The reaction results in a hydrodeoxygenation of the molecules in the feedstock.

Among other factors, it has been found that use of the present catalyst with the particular amounts of molybdenum (Mo), nickel (Ni), and phosphorus (P), excellent hydrodeoxygenation with high selectivity can be achieved. A more efficient and effective process for hydrodeoxygenation of bio feeds is the result.

### DETAILED DESCRIPTION

As used herein and in the appended claims, singular articles such as “a,” “an,” and “the” include plural referents unless the context clearly dictates otherwise. Thus, for example, reference to “a step” may include multiple steps, reference to “producing” or “products” of a reaction or treatment should not be taken to be all of the products of a reaction/treatment, and reference to “treating” may include reference to one or more of such treatment steps. As such, the step of treating can include multiple or repeated treatment of similar materials/streams to produce identified treatment products.

Value or ranges may be expressed herein as “about”, from “about” one particular value, and/or to “about” another particular value. When such values or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±15% of the stated value, ±10% of the stated value, ±5% of the stated value, ±3% of the stated value, ±2% of the stated value, or ±1% of the stated value.

The present application relates to a process and catalyst that produces hydrodeoxygenated products from starting materials, feedstocks, of biological origin. The catalyst has specific amounts of molybdenum, as well as nickel and phosphorus. The use of the catalyst in the present process offers high activity and selectivity in the HDO reaction.

Impregnation, such as impregnation by incipient wetness or ion exchange in solution, is a commonly used technique for introducing metals into a catalyst that includes a support. During impregnation, a support is exposed to a solution containing a salt of the metal for impregnation. Multiple exposure steps can optionally be performed to achieve a desired metals loading on a catalyst. For example, catalysts including both molybdenum and nickel can be synthesized by co-impregnation of molybdenum and nickel complexes onto a catalytic support. Optionally, catalysts including both molybdenum and nickel can be formed by sequential impregnation of molybdenum and nickel complexes onto a catalyst support. For example, a catalyst may be prepared by a sequential impregnation where nickel is impregnated first, and then molybdenum is impregnated on the nickel-containing catalyst. Without being bound by any theory, it is believed that sequential impregnation can result in improved distribution of molybdenum (and optionally nickel) on a support After each metal impregnation step in a sequential impregnation process, a metal-impregnated support may be subjected to a drying step by which at least a portion of the volatiles content is driven from the metal-impregnated support but leaving the metals behind upon the surface of the support. The metal-impregnated doped support particle may be dried under drying conditions that include a drying temperature that is less than a calcination temperature. Typically, the drying temperature will be conducted at a temperature in the range of from 110° C. to 200° C.

The catalyst used in the present process can be prepared by creating a stable impregnating solution comprising an aqueous solution of a molybdenum precursor compound, a nickel precursor compound and a phosphorus precursor component. Any suitable precursor compound for the Mo, Ni, and P can be used as long as the precursors provide the components in the aqueous solution. Examples of molybdenum precursors include molybdenum trioxide, ammonium dimolybdate, and ammonium heptamolybdate. In one embodiment, the precursor compound for Mo is molybdenum trioxide. Examples of nickel precursors include nickel carbonate and nickel nitrate. In one embodiment, the nickel precursor is nickel carbonate. The phosphorus precursor may be an acid or salt, for example phosphoric acid (H₃PO₄), phosphorous acid (H₃PO₃), hypophosphorous acid (H₃PO₂), ammonium dihydrogen phosphate (NH₄H₂PO₄), ammonium hydrogen phosphate (NH₄)₂HPO₄. In one embodiment, the phosphorus precursor is phosphoric acid. The component weights can be varied to ensure solution stability, as well as the proper concentration and ratio of metals. Component weights, order of addition, temperature, and reaction times required are well known to those skilled in the art.

Generally, the catalyst described herein can be produced using alternative methods. In an impregnation method (note that pre-and post-impregnation methods are further described below), a powdered porous support material (e.g., an alumina-containing powder such as pseudo-boehmite) is mixed with water and then extruded to form a pelleted catalyst support. The support is dried and calcined, and a Mo metal compound or precursor, a Ni metal compound or precursor and a P compound or precursor are impregnated onto the support. The impregnated wet pellets are then dried and calcined to provide supported catalysts. In another preparation method, a powdered porous support material (e.g., an alumina-containing powder, such as pseudo-boehmite) and catalytic metal precursors, water, and additives such as extrusion aids, peptizing chemicals, and the like, are combined, mixed, and shaped into pellets. The metal-containing wet pellets are then dried and calcined to produce the supported catalyst.

“Pre-impregnated” catalyst refers to a catalyst in which the metals-containing solution or solutions are added before the porous catalyst support is calcined. The metals-containing solution or solutions can be added prior to or after shaping of the catalyst particle, but the important aspect is that the metals-containing solution or solutions be added prior to the support material being calcined. However, there are significant advantages to be gained by shaping of the uncalcined support after impregnation (contact) with an aqueous solution containing one or more catalytic metals. These advantages are observed in the form of more desirable distribution of the metals throughout the support in the final catalyst. Thus, a “pre-impregnated” catalyst can be made as follows:

A powdered uncalcined porous support (e.g., an alumina-containing support such as pseudo-boehmite) is thoroughly mixed with water, or optionally with a dilute aqueous solution of nitric acid, and the mixture is combined with a suitable quantity of a stable metals solution. Such solution typically contains at least one Mo metal compound or precursor and at least one Ni metal compound or precursor, and phosphorus, plus an optional additional quantity of metals solution of one or more metals of Group VIIIB, if required in order to provide the desired amount of metals on the finished catalyst. Note that the one or more metals of Group VIIIB is typically selected to be water-soluble under the temperature conditions encountered. Additionally, a chelating agent or compound can optionally be included in the impregnating solution.

The metal-containing mixture, typically containing about 50 to about 65 wt. % moisture, is shaped into catalyst particles having a desired size and shape, preferably by extrusion. The formed catalyst particles are dried at a temperature of about 110° C. to about 200° C. and then calcined at a temperature of about 500° C. to about 1000° C. for about one to two hours.

“Post-impregnated” catalyst refers to a catalyst in which the metals-containing solution or solutions are added after the porous catalyst support is calcined. Suitable calcining conditions for the support per se are described hereinabove. The porous catalyst support can be calcined before or after shaping of the catalyst support particle, but the important aspect of post-impregnation is that the metals-containing solution or solutions be added after the support material is calcined. Thus, a “post-impregnated”catalyst can be made as follows:

Powdered uncalcined porous support (e.g., alumina-containing support such as pseudo-boehmite) is thoroughly mixed with water, or optionally with a dilute aqueous solution of nitric acid, and the mixture, containing about 50 to 75 wt. % moisture, is then formed into catalyst particles having a desired size and shape, preferably by extrusion. The formed particles are dried at a temperature of about 110° C. to about 200° C. and then calcined at a temperature of about 500° C. to about 1000° C. for about one to two hours. The dried and calcined particles are contacted with a suitable quantity of a stable metals solution. For example, such solution typically contains molybdenum, nickel and phosphorus, plus an optional additional quantity of solution of one or more metals of Group VIIIB, if required, in order to provide the desired amount of metals on the finished catalyst, while substantially and uniformly filling the pores. After a suitable contact time, the formed catalyst particles are dried according to one of the alternative conditions described immediately above.

It will be observed that a significant distinction between a pre-impregnated catalyst and a post-impregnated catalyst is that the post-impregnated catalyst undergoes two calcining steps; typically, one consisting essentially of calcining the porous support and the second after which the calcined support has been impregnated with the catalytically active metal components and with a phosphorus component. In contrast, the pre-impregnated catalyst undergoes one calcining step, as described.

The molybdenum will usually be present in an amount of about 6 to about 16 wt. %, calculated as elemental metal and based on the total weight of the catalyst composition, for example, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, or any range including and/or in between any two of these values. The nickel will usually be present in an amount of from about 0.1 to about 1.3 wt. %, calculated as elemental metal and based on the total weight of the catalyst composition, for example, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1.0 wt. %, about 1.1 wt. %, about 1.2 wt. %, about 1.3 wt. %, or any range including and/or in between any two of these values. Phosphorus is usually present in an amount of from 0.5 to about 2.9 wt. %, calculated as elemental phosphorus and based on the total weight of the catalyst composition, for example, about 0.5 wt. %, about 0.7 wt. %, about 0.9 wt. %, about 1.0 wt. %, about 1.1 wt. %, about 1.3 wt. %, about 1.5 wt. %, about 1.7 wt. %, about 1.9 wt. %, about 2.1 wt. %, about 2.3 wt. %, about 2.5 wt. %, about 2.9 wt. %, or any range including and/or in between any two of these values. The amount of molybdenum and nickel metals present in the catalyst composition can be measured using atomic absorption spectrometry (AAS), inductively coupled plasma spectroscopy (ICP) analysis and/or x-ray fluorescence (XRF). The combination of Mo, Ni, and P in such amounts has been found to be quite effective for the present purposes of hydrodeoxygenation of a bio feed, offering high activity and selectivity. Besides the Mo, Ni, and P components, the remainder of the catalyst is generally a support material. Any suitable support material can be used, but generally the support material is an inorganic oxide, and in one embodiment the support material comprises an alumina.

The catalyst composition may have different shapes selected for their suitability for the process and/or equipment in which they are to be used. For example, if the catalyst composition is to be used in slurry-type reactors, fluidized beds, moving beds (e.g., an on-line catalyst replacement reactor or OCR reactor), or expanded beds (e.g., an upflow reactor or UFR), generally spray-drying or beading is applied. For fixed bed or ebullating bed applications, generally the catalyst composition is extruded, pelletized, and/or beaded. In the latter case, at any stage prior to or during the shaping step, any additives, which are conventionally used to facilitate shaping, can be added. These additives may comprise aluminum stearate, surfactants, graphite, starch, methyl cellulose, bentonite, polyethylene glycols, polyethylene oxides, or mixtures thereof. Further, as discussed elsewhere, when alumina is used as the carrier, nitric acid is sometimes added prior to the shaping step for the purpose of, for example, increasing the mechanical strength of the agglomerates. In the present disclosure, the shaping step is carried out in the presence of water. For extrusion and beading, the amount of water in the shaping mixture, expressed as loss-on-ignition (LOI), preferably is in the range of 20-80%. If required by the shaping operation, additional water can be added or, if the amount of water is too high, it can be reduced by, e.g., solid-liquid separation via, e.g., filtration, decantation, or evaporation. It is within the scope of the skilled person to control the amount of water appropriately.

Suitable shapes include powders, spheres, cylinders, rings, and symmetric or asymmetric polylobal forms, for instance tri-and quadrilobal. Catalysts in the form of pellets or spheres are generally preferred. Average catalyst particles sizes are preferably in the range of from about 0.3 mm to about 6.0 mm, more preferably in the range of from about 0.6 mm to about 5.0 mm.

The specific surface area of the catalyst is not particularly limited. Generally, the specific surface area of the catalyst can range from about 100 to about 260 m2/g, alternatively from about 110 to about 250 m²/g, or alternatively from about 120 to about 240 m²/g. The total pore volume by mercury porosimetry (ASTM D4284) can range from about 0.50 to about 1.15 cm³/g, alternatively from about 0.55 to about 1.10 cm³/g, or alternatively from 0.60 to 1.05 cm³/g. Pores having a diameter of 50 to 150 Å are measured by nitrogen porosimetry. The procedure for measuring pore volumes by nitrogen physisorption is as disclosed and described in D. H. Everett and F. S. Stone, Proceedings of the Tenth Symposium of the Colston Research Society, Bristol, England: Academic Press, March 1958, pp. 109-110. In some embodiments, the mercury pore volume in pores of a diameter greater than 150 Å is from 0.25 to 0.80 cm³/g, for example, about 0.25 cm³/g, about 0.30 cm³/g, about 0.35 cm³/g, about 0.40 cm³/g, about 0.45 cm³/g, about 0.50 cm³/g, about 0.55 cm³/g, about 0.60 cm³/g, about 0.65 cm³/g, about 0.70 cm³/g, about 0.75 cm³/g, about 0.80 cm³/g, or any range including and/or in between any two of these values. In embodiments, the nitrogen pore volume in pores of a diameter of about 50 to about 150 Å is from 0.10 to 0.70 cm³/g, for example, about 0.10 cm³/g, about 0.15 cm³/g, about 0.20 cm³/g, about 0.25 cm³/g, about 0.30 cm³/g, about 0.35 cm³/g, about 0.40 cm³/g, about 0.45 cm³/g, about 0.50 cm³/g, about 0.55 cm³/g, about 0.60 cm³/g, about 0.65 cm³/g, about 0.70 cm³/g, or any range including and/or in between any two of these values.

The supported catalyst composition following impregnation, drying and calcinations, i.e., wherein the metal-containing components and phosphorus are present as their oxides, and, preferably, prior to a sulfidation step, if any, exhibit the properties described above.

The present technology is also directed to catalyst compositions wherein the metal components have been converted partly or wholly into their sulfides.

Preferably, the catalyst comprises sulfided catalytically active metals. Catalyst metals are often in an oxide state when charged to a reactor and preferably activated by reducing or sulfiding the metal oxide. Hydroprocessing catalysts are generally more active in a sulfided form as compared to an oxide form of the catalyst. A sulfiding procedure is used to transform the catalyst from a calcined oxide state to an active sulfided state. Catalyst may be pre-sulfided or sulfided in situ. Because renewable feedstocks generally have a low sulfur content, a sulfiding agent is often added to the feed to maintain the catalyst in a sulfided form.

As mentioned above, the catalyst may be sulfided in-situ or ex-situ. In-situ sulfiding may be achieved by supplying a sulfur source, usually H₂S or an H₂S precursor (i.e., a compound that easily decomposes into H₂S such as, for example, dimethyl disulfide, di-tert-nonyl polysulfide or di-tert-butyl polysulfide) to the hydroprocessing catalyst during operation of the process. The sulfur source may be supplied with the feed, the hydrogen stream, or separately. An alternative suitable sulfur source is a sulfur-comprising hydrocarbon stream boiling in the diesel or kerosene boiling range that is co-fed with the feedstock. In addition, added sulfur compounds in feed facilitate the control of catalyst stability and may reduce hydrogen consumption.

The bio feedstock includes any suitable bio feedstock. As used herein, a bio feedstock refers to a feedstock from a renewable source. A renewable source may be animal, vegetable, microbial, and/or bio-derived waste materials suitable for the production of fuels, fuel components and/or chemical feedstocks.

One suitable class of bio feedstocks includes lipid compounds. A “lipid” as used herein refers to fats, oils, and greases. Lipids are comprised of saturated and unsaturated fatty acids in the C₈-C₂₄ range, wherein the fatty acids can be in the form of esters of glycerin (i.e., as mono-, di-, and triglycerides), or as free fatty acids (FFA). Exemplary lipid feedstocks include, but are not limited to, an animal fat, animal oil, microbial oil, plant fat, plant oil, vegetable fat, vegetable oil, grease, or a mixture of any two or more thereof. Plant and/or vegetable oils and/or microbial oils include, but are not limited to, corn oil, distiller's corn oil, inedible corn oil, babassu oil, carinata oil, soybean oil, canola oil, coconut oil, rapeseed oil, tall oil, tall oil fatty acid, palm oil, palm oil fatty acid distillate, palm sludge oil, jatropha oil, palm kernel oil, pennycress oil, sunflower oil, castor oil, camelina oil, archaeal oil, bacterial oil, fungal oil, protozoal oil, algal oil, seaweed oil, oils from halophiles, and mixtures of any two or more thereof. These may be classified as crude, degummed, and RBD (refined, bleached, and deodorized) grade, depending on level of pretreatment and residual phosphorus and metals content. However, any of these grades may be used in the present technology. Animal fats and/or oils as used above include, but are not limited to, inedible tallow, edible tallow, technical tallow, floatation tallow, bleachable fancy tallow, lard, technical lard, choice white grease, poultry fat, poultry oils, fish fat, fish oils, and mixtures of any two or more thereof. Greases may include, but are not limited to, choice white grease, yellow grease, brown grease, used cooking oils, restaurant greases, trap grease from municipalities such as water treatment facilities, and spent oils from industrial packaged food operations, and mixtures of any two or more thereof.

For example, in any embodiment, the lipid may include palm oil, canola oil, soybean oil, distillers corn oil, algal oil, poultry fat, tallow, choice white grease, used cooking oil, yellow grease, brown grease, palm sludge oil, fatty acid distillate, or a combination of any two or more thereof.

In embodiments, derivatives of such lipids, such as fatty acid alkyl esters formed via transesterification or esterification of the lipid with an alcohol, may be used. Examples include fatty acid methyl esters and fatty acid ethyl esters.

Depending on level of pretreatment, the lipid feedstock may contain between about 1 wppm and about 1000 wppm phosphorus, and between about 1 wppm and about 2000 wppm total metals (mainly sodium, potassium, magnesium, calcium, iron, and copper). The lipid may also contain up to about 40 wt. % free fatty acid (FFA). The FFA content of the lipid may be about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 30 wt. %, about 32 wt. %, about 34 wt. %, about 36 wt. %, about 38 wt. %, about 40 wt. %, or any range including and/or in between any two of these values.

The lipid feedstock contains fatty acid-bound glycerol (or bound glycerol for short) in the form of glycerides (sum of monoglycerides, diglycerides, and triglycerides). The lipid feedstock may contain up to 99.6 wt. % glycerides. The glycerides content of lipid feedstock may be about 20 wt. %, about 30 wt. %, about 40 wt. %, about 50 wt. %, about 60 wt. %, about 70 wt. %, about 90 wt. %, or about 99.6 wt. %, or between any two values within this range. For example, the lipid feedstock may contain a glycerides content in the range of 20 wt. % to 99.6 wt. %, or in the range of 30 wt. % to 80 wt. %.

Another suitable class of bio feedstocks includes liquids derived from biomass liquefaction processes. Examples of such liquefaction processes include (hydro)pyrolysis, hydrothermal liquefaction, torrefaction, catalytic cracking, and combinations thereof. Examples of biomass include, but are not limited to, municipal solid waste, food waste, sewer sludge, manure, forestry residues (e.g., tree thinnings, sawdust, wood chips, etc.), renewable fuel residues, pulp and paper residues (e.g., black liquor), agricultural residues (e.g., corn stover, bean stover, sugar cane bagasse, etc.), herbaceous energy crops (e.g., switchgrass, miscanthus, etc.), woody energy crops (e.g., hybrid poplar, southern yellow pine, etc.), aquatic energy crops (e.g., algae, seaweed, etc.), and mixtures of any two or more thereof. Bio-oils may be used alone or in combination with lipid feedstocks.

The present technology is most particularly advantageous in the processing of feed streams comprising substantially 100% bio feedstocks. However, in one embodiment of the present technology, bio feedstock may be co-processed with petroleum-derived hydrocarbons. Petroleum-derived hydrocarbons include, without limitation, all fractions from petroleum crude oil, natural gas condensate, tar sands, shale oil, synthetic crude, and combinations thereof. At a bio feed content in a range of from 1 to 30 wt. %, the petroleum-derived hydrocarbons will generally provide a diluting effect and/or heat sink effect. Accordingly, the present technology is more particularly advantageous for a combined bio and petroleum-derived feedstock comprising a bio feedstock content in a range of from 30 to 99 wt. %, preferably from 40 to 99 wt. %.

In the present technology, the bio feedstock is subjected to hydrotreatment in the presence of hydrogen over sulfided forms of the catalyst described hereinabove. During hydrotreating, a number of different reactions occur, including, for example, hydrogenation, decarboxylation, decarbonylation, and/or hydrodeoxygenation. In hydrogenation reactions, olefinic compounds are saturated by addition of hydrogen. In decarboxylation reactions, oxygen is removed as carbon dioxide. In decarbonylation reactions, oxygen is removed as carbon monoxide. In hydrodeoxygenation reactions, oxygen is removed as water. Cracking reactions can also occur during hydrotreating in which larger molecules (e.g., hydrocarbons) are broken down into shorter-chain molecules.

Generally, the hydrotreating conditions include a pressure of about 500 to about 3000 psig (3.45 to 20.68 MPa gauge), and in one embodiment from about 1000 to about 2400 psig (6.89 to 16.55 MPa gauge). The hydrotreating reaction temperature range is typically from 400° F. to 800° F. (204° C. to 427° C.), and in one embodiment from 500° F. to 700° F. (260° C. to 371° C.). For hydrotreating, fixed-bed and/or slurry reactor systems and operating conditions may be used. In some embodiments, continuous reactor systems are used. In some embodiments, continuous fixed-bed reactors are used. In continuous fixed-bed reactor systems, the liquid hourly space velocity (LHSV) is from 0.2 h−1 to 10 h−1, and the hydrogen gas-to-oil ratio is from 200 NL/L to 2000 NL/L. In some embodiments with continuous fixed-bed reactor systems, the LHSV is from 0.5 h−1 to 5.0 h−1. In some embodiments with continuous fixed-bed reactor systems, the hydrogen gas-to-oil ratio is from 400 NL/L to 1600 NL/L.

Hydrotreating is carried out in the presence of hydrogen. A hydrogen stream is, therefore, fed or injected into a vessel or reaction zone or hydroprocessing zone in which the present catalyst is located. Hydrogen, which is contained in a hydrogen containing “treat gas,” is provided to the reaction zone. Treat gas can be either pure hydrogen or a hydrogen-containing gas, which is a gas stream containing hydrogen in an amount that is sufficient for the intended reaction(s), optionally including one or more other gases (e.g., nitrogen and light hydrocarbons such as methane), and which will not adversely interfere with or affect either the reactions or the products. Impurities, such as H₂S and NH₃ are undesirable and would typically be removed from the treat gas before it is conducted to the reactor. The treat gas stream introduced into a reaction stage will preferably contain at least about 50 vol % and more preferably at least about 75 vol % hydrogen.

The hydrotreating reaction step produces an effluent comprising a hydrotreated liquid and a vapor phase comprising hydrogen and by-products of the hydrotreating reaction such as H₂O, CO, CO₂ and light hydrocarbons (typically C₁ to C₃ hydrocarbons). The effluent may be separated into one or more liquid streams and one or more offgas streams.

In a preferred embodiment of the present technology, the process comprises a hydrotreating reaction and an additional reaction selected from a hydroisomerization reaction, a selective hydrocracking reaction and/or a hydrodearomatization reaction. The hydrotreating reaction and the additional reaction(s) may be accomplished in a single stage or multiple stage process. One or more of the hydrotreating reaction and additional reaction(s) may be conducted step-wise and/or simultaneously by selecting the appropriate catalyst(s) and/or operating conditions.

The effluent from the hydrotreating reaction may contain significant amounts of n-paraffins in the C₉ to C₂₄ range. It is preferable to improve the cold flow properties of the liquid product(s) from the process of the present technology by processing at least part of the effluent from the hydrotreating step in a subsequent hydroisomerization reaction. In the hydroisomerization reaction, the stream comprising n-paraffins is contacted with a hydroisomerization catalyst under hydroisomerization conditions to at least isomerize part of the n-paraffins. Hydroisomerization processes and suitable hydroisomerization catalysts are known to the person skilled in the art.

It may also be desirable to selectively crack at least part of the hydrotreating effluent in a selective hydrocracking reaction. In the selective hydrocracking reaction, the stream comprising n-paraffins is contacted with a selective hydrocracking catalyst under hydrocracking conditions to at least crack part of the n-paraffins to molecules with a lower boiling range. Hydrocracking processes and suitable hydrocracking catalysts are known to the person skilled in the art. The selective hydrocracking reaction may be combined with the hydroisomerization reaction and/or the hydrotreating reaction.

The hydroisomerization reaction and/or selective hydrocracking reaction may follow the hydrotreating reaction without any separation step in between the steps.

In another embodiment, the effluent from the hydrotreating reaction is separated into a liquid phase and a gaseous phase. The liquid phase is sent to the additional reaction together with a hydrogen containing gas stream, not being the gaseous phase as obtained directly from the separation from the liquid phase. The liquid phase from hydrotreating reaction may be stripped from dissolved contaminants, such as e.g., CO, CO₂, H₂O, H₂S and NH₃, before being sent to the hydroisomerization step and/or selective hydrocracking step. The hydroisomerization step and/or hydrocracking step may be in co-current mode or in counter-current mode, preferably in co-current mode.

The effluent from one or more hydroprocessing reactions may be sent to fractionation to produce a gasoil boiling point range fraction, a diesel boiling point range fraction, a kerosene boiling point range fraction, a naphtha boiling point range fraction, and combinations thereof, as desired.

The following examples are provided to further illustrate the present catalyst and processes. The examples are not meant to be limiting.

### EXAMPLE 1

### Preparation of Catalyst A

An aqueous solution containing 13 wt. % Mo, 0.66 wt. % Ni and 2.1 wt. % P was prepared by heating water, nickel carbonate, phosphoric acid, and molybdenum trioxide to 190° F. and holding at 190° F. for four hours. An aliquot of this solution (113 g) was used to impregnate a transition alumina support. This alumina support was prepared by mixing a pseudoboehmite powder of 320 m²/g surface area with water and nitric acid and extruding the resulted dough, followed by drying and calcination. The support had a surface area of 176 m²/g and a total mercury pore volume of 0.905 cm³/g. Catalyst A had an asymmetric quadrilobe shape of 1/20″ size and contained 11.3 wt. % Mo, 0.53 wt. % Ni and 1.68 wt. % P as active components (Ni/Mo molar ratio=0.08, P/Mo molar ratio=0.5).

Catalyst A had the following properties: a surface area of 136 m²/g, a total mercury pore volume 0.65 cm³/g, and a mercury pore volume above 150 Å of 0.51 cm³/g. Measured by nitrogen porosimetry, the pore volume in pores with a diameter of 50 to 150 Å was 0.28 cm³/g.

### Example 2

### Evaluation of Catalytic Performance

The present Catalyst A was layered behind a Catalyst B with 3% Mo, 0.4% Ni, and 0.1% P in testing for hydrodeoxygenation using a feed blend of canola oil with a paraffinic solvent having an API of 39.3° at 1680 psig pressure, 0.7 h-1 LHSV, and 10000 SCF/bbl hydrogen to oil ratio to simulate a commercial unit operation. Both catalysts were sulfided first. The oxygen conversion was 98% with Catalyst A at 560° F. Catalyst B operated at 555° F. to process the feed with partial deoxygenation. The product API was 46.2°. The HDO selectivity was 86%. The levels of CO and CO₂ were 0.07% and 0.21%, respectively, in product gas.

### Reference Example 1

### Evaluation of Catalyst Performance

A conventional hydrotreating Catalyst C with 15.8 wt. % Mo, 4.5 wt. % Ni and 2.7 wt. % P was layered behind a Catalyst D with 10% Mo and tested under the same pressure, LHSV, and hydrogen to oil ratio as in Example 2. The oxygen conversion was 98% with Catalyst C at 560° F. Catalyst D operated at 520° F. to process the feed with partial deoxygenation. The product API was 46.2°. The HDO selectivity was 82%. The levels of CO and CO₂ were 0.17% and 0.31%, respectively, in product gas. Therefore, the inventive method of layering Catalyst A after B has better HDO selectivity than the reference case based on both liquid product and gas analysis. The use of the present catalyst, catalyst A, offered higher selectivity with similar activity.

### Example 3

### Preparation of Catalyst E

An aqueous solution containing 17.4 wt. % Mo, 0.809 wt. % Ni and 2.57 wt. % P was prepared by heating water, nickel carbonate, phosphoric acid, and molybdenum trioxide to 190° F. and holding for four hours. An aliquot of this solution (44.5 g) was used to impregnate a gamma alumina support. The alumina support was prepared by mixing a high surface silica-alumina powder and a high surface area alumina with water and nitric acid and extruding the resulting dough, followed by drying and calcination. The support had a surface area of 317 m²/g, a total pore volume of 1.368 cm³/g. Catalyst E had an asymmetric quadrilobe shape of 1/2041 size and contained 11.4 wt. % Mo, 0.455 wt. % Ni and 1.52 wt. % P as active components (Ni/Mo molar ratio=0.08, P/Mo molar ratio=0.5).

Catalyst E had the following properties: a surface area of 229 m²/g and a total mercury pore volume of 0.99 cm³/g, and a mercury pore volume above 150 Å of 0.66 cm³/g. Measured by nitrogen porosimetry, the pore volume in pores with a diameter of 50 to 150 Å was 0.55 cm³/g.

### Example 4. Evaluation of Catalytic Performance

Catalyst E was layered behind Catalyst B with 3% Mo, 0.4% Ni, and 0.1% P in testing for hydrodeoxygenation using a feed blend of canola oil with a paraffinic solvent having an API of 39.3°at 1680 psig pressure, 0.7 h-1 LHSV, and 10000 SCF/bbl hydrogen to oil ratio to simulate commercial unit operation. Both catalysts were sulfided first. The oxygen conversion was 98% with catalyst E at 560° F. Catalyst B operated at 560° F. to process the feed with partial deoxygenation. The product had an API gravity of 46.3°. The HDO selectivity was 92%. The levels of CO and CO₂ were 0.06% and 0.10%, respectively, in product gas.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements except for only minor traces of impurities.

As those skilled in the art will appreciate, numerous modifications and variations of the present invention are possible considering these teachings, and all such are contemplated hereby. For example, in addition to the embodiments described herein, the present invention contemplates and claims those inventions resulting from the combination of features of the invention cited herein and those of the cited prior art references which complement the features of the present invention. Similarly, it will be appreciated that any described material, feature, or article may be used in combination with any other material, feature, or article, and such combinations are considered within the scope of this invention.

All of the publications cited in this disclosure are incorporated by reference herein in their entireties for all purposes.

What is claimed is:

1. A process for hydrotreating a bio feedstock comprising:
providing a bio feedstock;
passing the bio feedstock to a reactor comprising a catalyst comprised of about 6 to 16 wt. % Mo, 0.1 to 1.3 wt. % Ni and 0.5 to 2.9 wt. % P, and
reacting the feedstock over the catalyst.

2. The process of claim 1, wherein the catalyst is comprised of about 9 to 15 wt. % Mo, 0.2 to 1.0 wt. % Ni, and 1.0 to 2.5 wt. % P.

3. The process of claim 1, wherein the catalyst components Mo, Ni, and P are impregnated into a porous support.

4. The process of claim 3, wherein the porous support comprises alumina.

5. The process of claim 1, wherein the catalyst has been pre-impregnated, shaped, dried and calcined.

6. The process of claim 1, wherein the catalyst has been post-impregnated, dried and calcined.

7. The process of claim 1, wherein the catalyst is in the shape of pellets or spheres.

8. The process of claim 1, wherein the catalyst has a specific surface area of 100 to 260 m²/g and/or a total pore volume of 0.50 to 1.15 cm³/g.

9. The process of claim 1, wherein the catalyst has one or more of the following properties: a mercury pore volume in pores of a diameter greater than 150 Å of from 0.25 to 0.80 cm³/g, and a nitrogen pore volume in pores of a diameter of about 50 to about 150 Å of from 0.10 to 0.70 cm³/g.

10. The process of claim 1, wherein the bio feedstock is selected from the group consisting of a lipid, liquid derived from a biomass liquefaction process, and a combination thereof.

11. The process of claim 10, wherein the lipid comprises palm oil, canola oil, soybean oil, distillers corn oil, algal oil, poultry fat, tallow, choice white grease, used cooking oil, yellow grease, brown grease, fatty acid distillate, or a combination thereof.

12. The process of claim 10, wherein the lipid has a total glycerides content of from 20 wt. % to 99.6 wt. %.

13. The process of claim 1, wherein the reacting occurs at a reaction temperature in the range of about 400° F. to 800° F. (204° C. to 427° C.).

14. A catalyst useful in hydrotreating bio feedstocks which comprises Mo, Ni, and P and a support material, wherein the catalyst is comprised of about 6 to 16 wt. % Mo, 0.1 to 1.3 wt. % Ni, and 0.5 to 2.9 wt. % P based on the total weight of the catalyst.

15. The catalyst of claim 14, wherein the catalyst is in the shape of pellets or spheres.

16. The catalyst of claim 14, wherein the catalyst has been pre-impregnated, shaped, dried and calcined.

17. The catalyst of claim 14, wherein catalyst has been post-impregnated, dried and calcined.

18. The catalyst of claim 14, having a specific surface area of 100 to 260 m²/g and/or a total pore volume of 0.50 to 1.15 cm³/g.

19. The catalyst of claim 14, wherein the catalyst has one or more of the following properties:
a mercury pore volume in pores of a diameter greater than 150 Å of from 0.25 to 0.80 cm³/g and a nitrogen pore volume in pores of a diameter of about 50 to about 150 Å of from 0.10 to 0.70 cm³/g.

20. The catalyst of claim 14, wherein the catalyst is comprised of about 9 to 15 wt. % Mo, 0.2 to 1.0 wt. % Ni, and 1.0 to 2.5 wt. % P.
